(19) United States
(12) Patent Application Publication
(10) Pub. No.: US 2022/0038799 A1
(43) Pub. Date: Feb. 3, 2022

(54) WEATHER RESISTANT SMART SPEAKER ENCLOSURE

(71) Applicant: Alexander Gribtsov, Freehold, NJ (US)

(72) Inventor: Alexander Gribtsov, Freehold, NJ (US)

(21) Appl. No.: 16/983,662

(22) Filed: Aug. 3, 2020

(51) Int. Cl. H04R 1/02

(52) U.S. Cl. CPC H04R 1/02

(57) ABSTRACT

A weather resistant smart speaker enclosure and a method for enclosing a smart speaker and protecting the smart speaker from the environment. The enclosure may have a top lid that can be opened or closed, may have a base portion with a chamber that houses a temperature sensor, a circuit for activating a heating coil that prevents the smart speaker from freezing, may have an external wall with cavities followed by an internal wall with cavities that are not aligned with the external wall cavities to prevent water from penetrating to the internal compartment where the smart speaker resides while allowing sound waves to travel in and out of the enclosure. May have drainage cavities at the base for the water between internal and external walls to drain out. Additionally, may have the ability to be mounted vertically or horizontally.

### FIELD OF INVENTION

This invention relates to enclosures for electronic devices with acoustic and communication capabilities such as a device that is in need of protection from weather elements, cold temperature and moisture.

### BACKGROUND

A smart speaker is a type of speaker and voice-command device with an integrated virtual assistant that offers hands-free interactive actions with the help of an activation word that grabs the speaker's attention. Some speakers can also act as a smart device utilizing Wi-Fi, Bluetooth and other protocol standards for communication and extended usage beyond audio playback such as interfacing with smart home devices and controlling them. There are many companies that have created different versions of these smart speaker devices and registered them under the following trademark names, for example Amazon Echo, Google Home, Apple HomePod and Sonos One.

Though these speakers are durable and designed for prolonged use, they are not designed for unpredictable outdoor weather and the assault of elements can disable the smart speaker's ability to operate properly. Naturally occurring events such as seasonal change and change in basic weather patterns can lower the temperature below the manufactured standards of the smart speaker and or the combination of rain and wind can push water into portions of the smart speaker that were not designed for liquid exposure and disable the device, even morning mildew can over time disable the device.

Many enclosures have been invented for speakers and smart devices. There is a compromise when it comes to placing speakers in weather resistant enclosures. For one, many enclosures will cause an acoustic loudness loss or displacement of sound waves. Another issue is being able to interact with the smart speaker's microphone system for input commands through the barrier intended for weather protection. Yet another issue is that if the temperature drops below the grade that the insulation of the enclosure was designed for, the smart speaker components can freeze and seize to function.

### SUMMARY

The following embodiments and aspects thereof are described and illustrated in conjunction with techniques, parts and methods which are meant to be exemplary and illustrative, not limiting in scope. In various embodiments, one or more of the embodiments are directed to other improvements.

In another aspect, a prospective enclosure for a smart speaker is provided. The protective enclosure can include a hard or soft shell made of any type of material that has a top lid opening which can be opened, and the smart speaker device inserted into it for protection and the lid can be closed. This aspect has multiple walls internally with cavities that overlap and drain holes at the bottom of the base so that any liquid can dispense out of the enclosure.

In a separate aspect, the present invention may take the form of a method of providing a weather resistant shield to any acoustic device without noticeably compromising the devices auditory output. This is achieved by creating an external physical barrier with many openings arranged in a pattern. Inside of the enclosure beyond the external barrier, there is an additional barrier wall with the same shape as the external wall but scaled down radius or area with many openings that overlap the openings of the external barrier. In between the barriers, on the bottom of the base of the enclosure, there are port holes that will allow any liquid that is trapped between the barriers to leak out. This concept of layered barriers can be repeated indefinitely to achieve total weather resistance while preserving a path for a sound wave from and to the enclosed device.

In certain embodiments, the base of the enclosure has a power cord feeding power to a circuit that will provide heat to create a heated microclimate within the enclosure. There is a temperature sensor connected to the circuit that will activate an electrical current if temperature inside the enclosure falls below a preprogramed state of degrees. The electric current will travel to a heating coil wire. The heating coil will produce heat and increase the temperature indefinitely or until a desired temperature is reached.

In certain embodiments, the enclosure has multiple mounting options for horizontal or vertical surfaces. For vertical surfaces there is a cavity in the bottom of the base with a depression for a mounting screw to be attached. For vertical surfaces there is a rectangular mounting bracket that is secured to a wall with two screws. A holster that is sized to get exactly over the mounting bracket is attached to the enclosure during production. Once the bracket is attached to a vertical wall, the enclosure with bracket holster slides over the bracket and the gravity holds the enclosure affixed to the vertical wall through the bracket.

### BRIEF DESCRIPTION OF THE DRAWINGS

Embodiments of the present invention will be described and explained through the use of the accompanying drawings in which:

FIG. 1 shows the top view of a smart speaker enclosure, according to an embodiment;

FIG. 2 shows the bottom view of a smart speaker enclosure, according to an embodiment;

FIG. 3 shows the front view of a smart speaker enclosure, according to an embodiment;

FIG. 4 shows the back view of a smart speaker enclosure, according to an embodiment;

FIG. 5 shows the right view of a smart speaker enclosure, according to an embodiment;

FIG. 6 shows the left view of a smart speaker enclosure, according to an embodiment;

FIG. 7 shows the ortho isometric view of a smart speaker enclosure, according to an embodiment;

FIG. 8 shows the prospective view of a smart speaker enclosure, according to an embodiment;

FIG. 9 shows the exploded view of a smart speaker enclosure, according to an embodiment;

FIG. 10 shows the sectional view of a smart speaker enclosure, according to an embodiment;

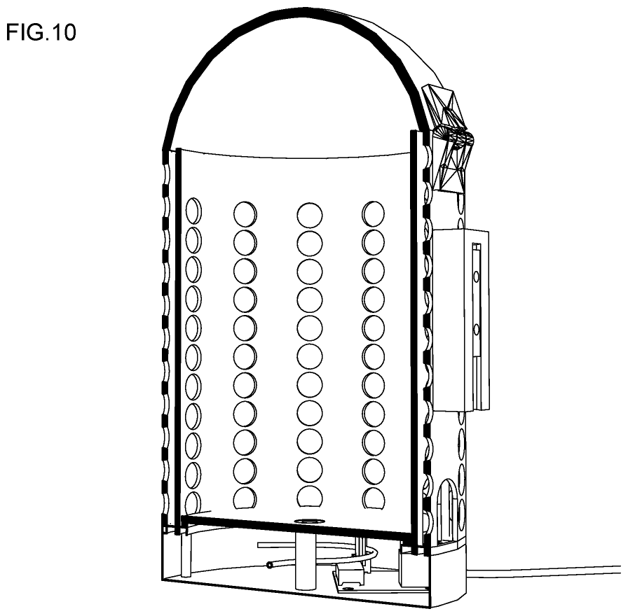

FIG. 11 shows the top view of an empty smart speaker enclosure with the top lid open, according to an embodiment;

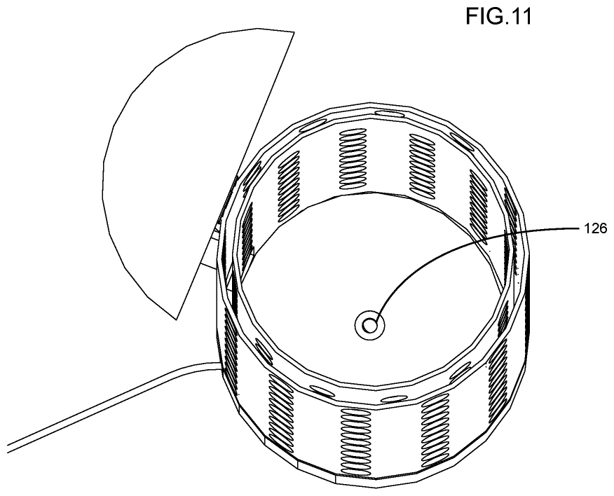

FIG. 12 shows the right view of an empty smart speaker enclosure with the top lid open, according to an embodiment;

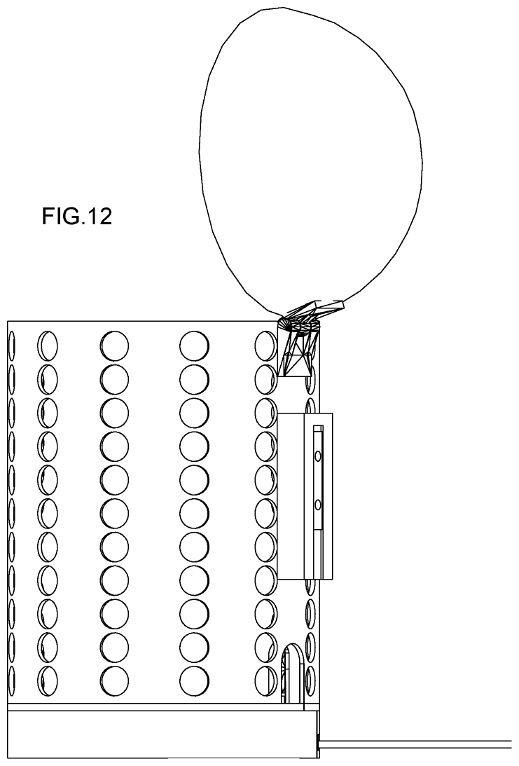

FIG. 13 shows the prospective view of an empty smart speaker enclosure with the top lid open, according to an embodiment;

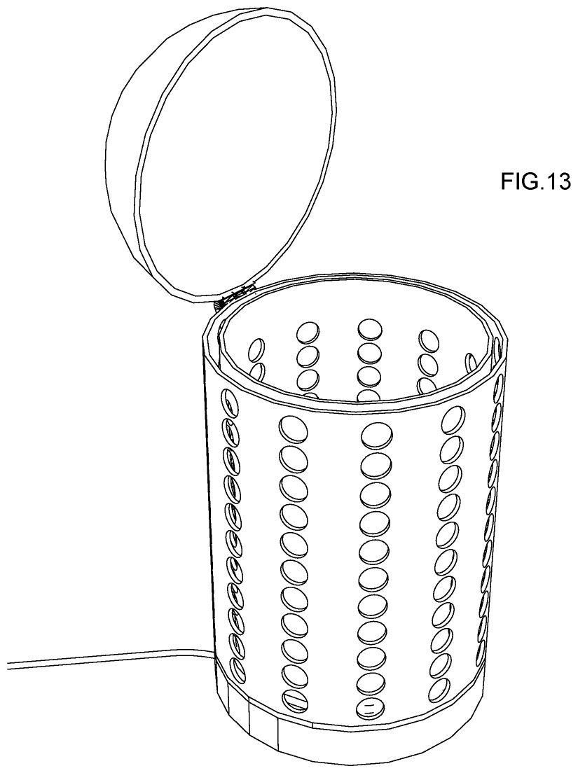

FIG. 14 shows the prospective view of an empty smart speaker enclosure with the top lid open and a smart speaker ready to be inserted into the enclosure, according to an embodiment;

FIG. 15 shows the prospective view of a smart speaker enclosure with the top lid open and smart speaker present in the enclosure chamber, according to an embodiment;

Various features, aspects and advantages of the embodiments will become more apparent from the following detailed description, along with the accompanying figures in which like numerals represent like components throughout the figures and text. The various described features are not necessarily drawn to scale but are drawn to emphasize specific features relevant to some embodiments.

### DETAILED DESCRIPTION

Reference will now be made in detail to various elements. Each example is provided by way of explanation and is not meant as a limitation and does not constitute a definition of all possible embodiments.

The term “weather resistant enclosure” may mean a structure that is capable of providing protection against at least one weather element such as temperature, wind or water.

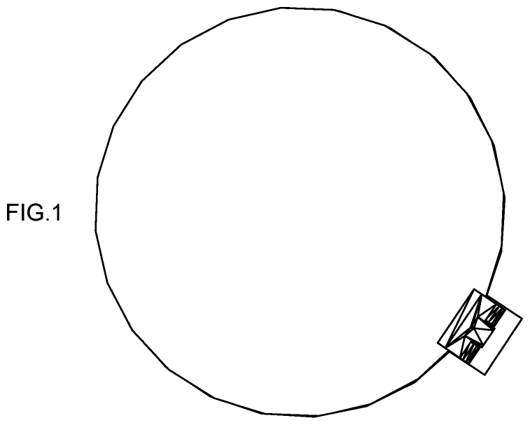

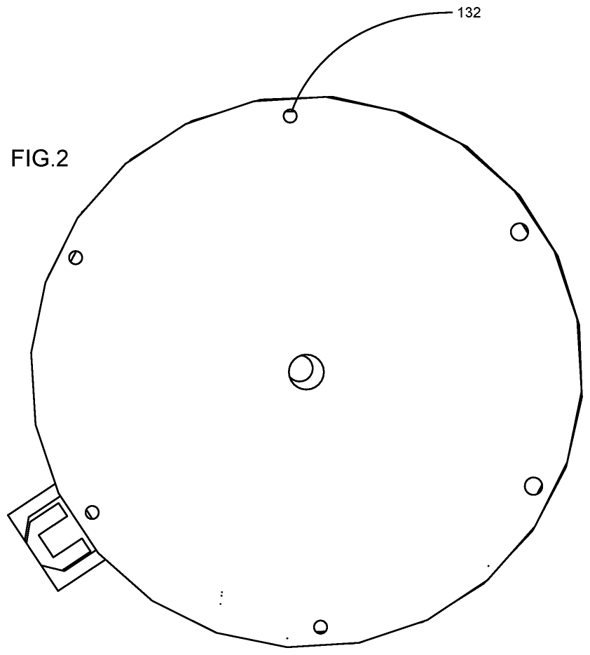

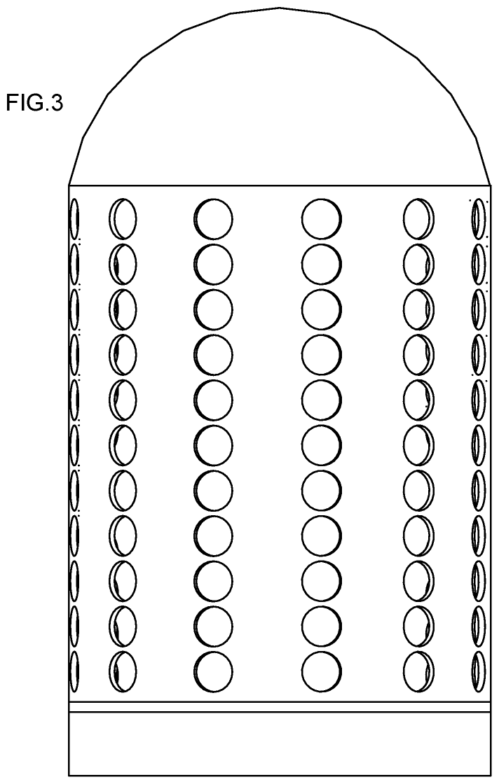

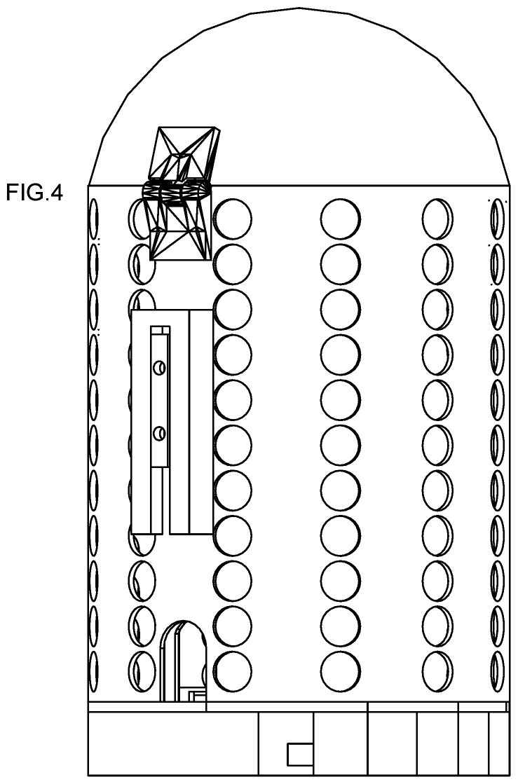

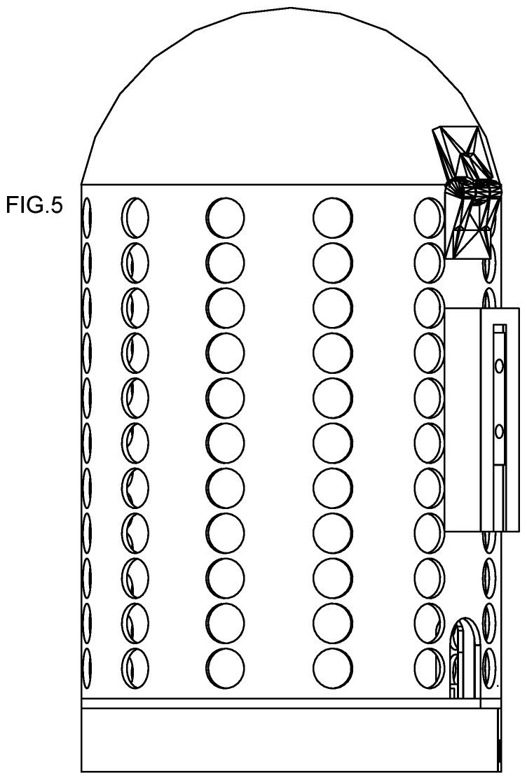

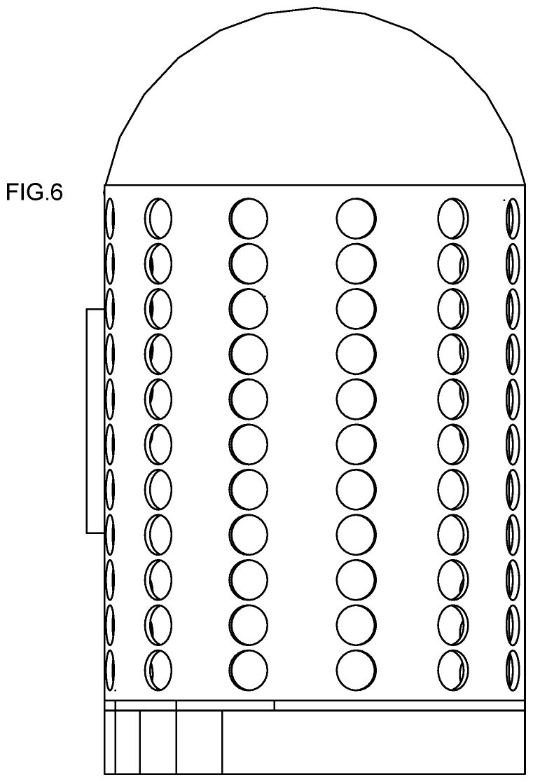

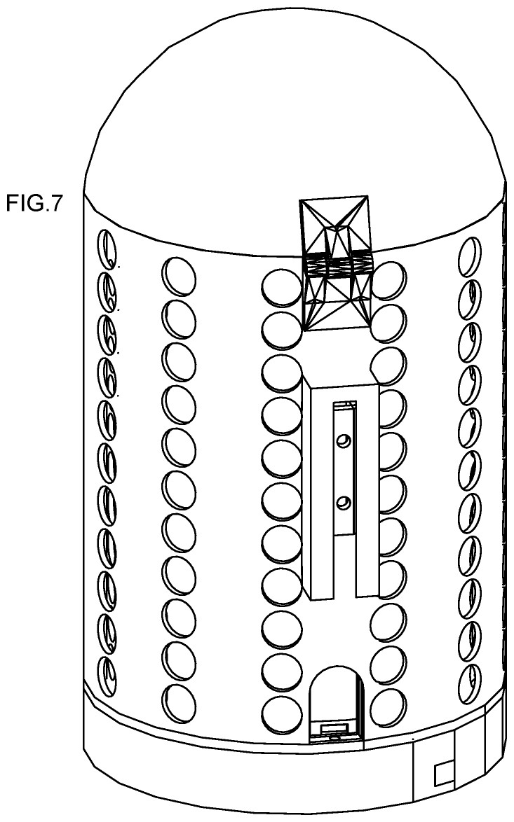

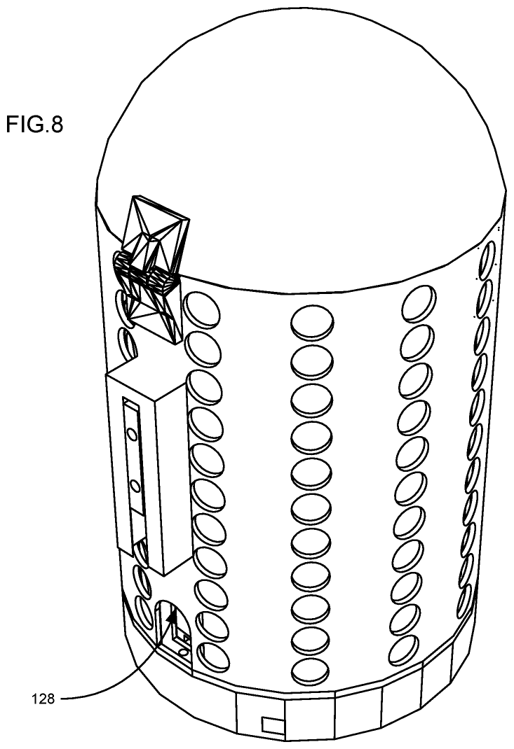

In reference to FIGS. 1-8, the weather resistant enclosure in its closed state helps provide basic protection from small projectiles and unpredictable weather. A skilled individual can rescale these dimensions to fit any height, width and shape smart speaker.

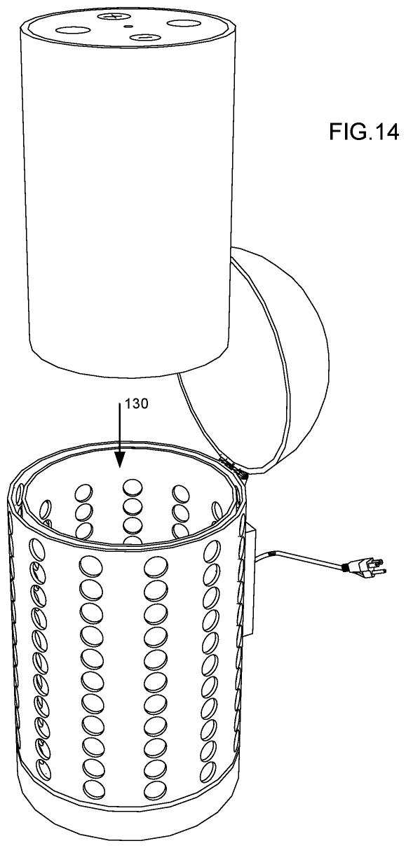

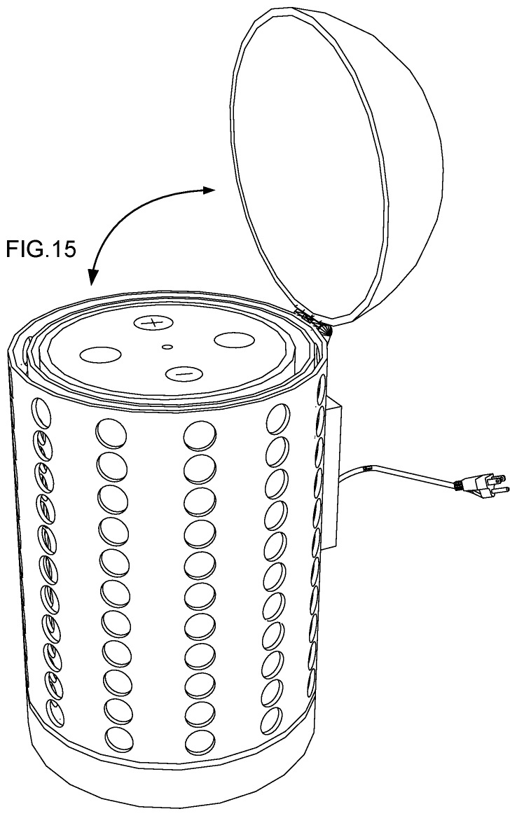

In reference to FIG. 15, the lid top cover 102 as indicated by the illustration and can be arranged into an opened or closed position. The lid 102 is attached with a lid hinge 104. Once the lid 102 is in open position, a smart speaker can be inserted into the weather resistant enclosure chamber 130 that is shown in FIG. 14. Once the smart speaker is in the chamber 130, the female power connector of the inserted smart speaker should align with the port opening for a smart speaker power cord connection 128.

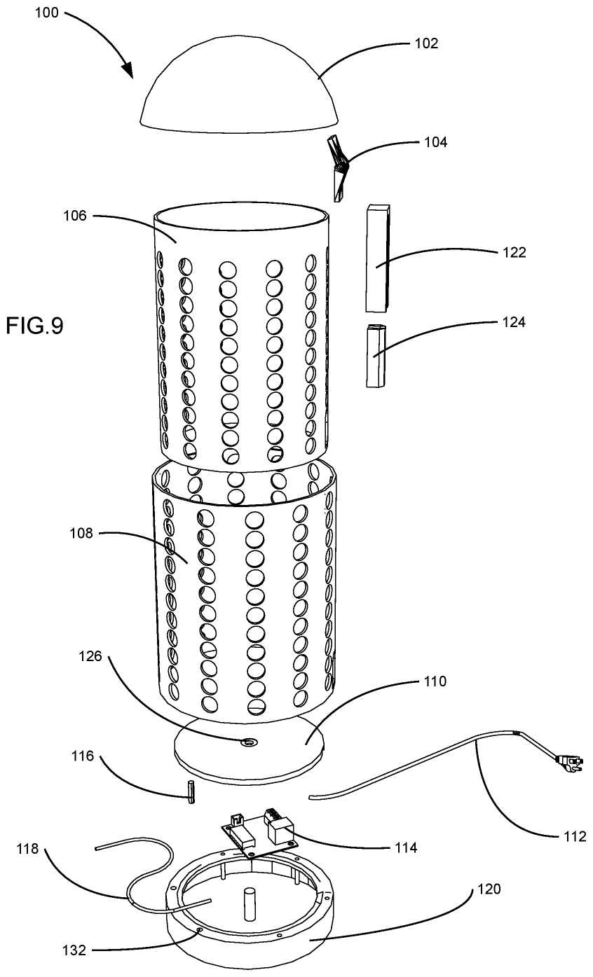

In reference to FIG. 9, one of the embodiments demonstrates the weather resistant enclosure is protected initially by an external enclosure wall 108, this wall 108 has a pattern of cavities that allow sound waves to pass through as well as some liquid from weather such as rain and mildew. As the water passes the cavities in the external wall 108, the water is met with the next internal enclosure wall 106 that is solid in places where the external wall 108 is not solid. The internal wall 106 also has cavity pattern but it is not aligned with the pattern of the external wall 108. This concept allows sound waves to come in and out of the enclosure while solid mater such as water will penetrate the first external wall 108 and then collide with the next internal wall 106 and be pulled down by gravity into the gap between the walls. At the bottom of this gap are multiple holes for draining liquid from weather and condensation 132. In some embodiments, a third or a fourth and even an indefinite number of walls can be added in the same cascading fashion to reinforce the water resisting concept while preserving the ability for sound waves to travel in and out of the enclosure.

In reference to FIG. 9, the internal wall 106 and external wall 108 both connect to the base with electronic compartment 120. In the compartment of the base are multiple electronics that have the ability to raise the enclosures internal temperature once it falls below a programmed temperature preset. These components are powered by a power cord 112. The internal temperature increase is achieved when the temperature sensor 116 reports an internal temperature to the circuit for detecting temperature and activating the heating coil 114 that is below the programed standard. Once the circuit 114 is activated, electricity is distributed to the heating coil 118 and temperature begins to rise. The circuit 114 is also programed to get a temp reading from the sensor 116 in periotic intervals. The content of all electronics in the base compartment 120 is covered by the base cover 110.

According to an embodiment, the weather resistant enclosure may be mounted to a vertical surface with mounting screws. For vertical mount, a bracket for vertical mounting 124 is used in combination with a bracket holster for vertical mounting 122. The bracket for vertical mounting 124 is first attached to a vertical surface with two screws, then the entire weather resistant enclosure is slid on top of the bracket 124 with the bracket holster 122 that is part of the enclosure exterior wrapping around the bracket for vertical mounting.

According to an embodiment, the weather resistant enclosure may be mounted to a horizontal surface with a mounting screw. For a horizontal mount, a screw is inserted into the horizontal mounting screw cavity 126. This takes place before the smart speaker is inserted into the enclosure.

The components of the apparatus illustrated are not limited to the specific embodiments described herein, but rather, features illustrated or described as part of one embodiment can be used on or in conjunction with other embodiments to yield yet a further embodiment. It is intended the apparatus include such modifications and variations. Further, steps described in the method may be utilized independently and separately from other steps described herein.

While the apparatus and method have been described with reference to specific embodiments, it will be understood by the those skilled in the art that various changes may be made, and equivalence may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the content clearly dictates otherwise. Furthermore, reference to “one embodiment”, “some embodiments”, “an embodiment” and like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Term such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability or possibility associated with a qualified verb. Accordingly, usage of “may” or “may be” indicates that a modified term is apparently appropriate, capable, or suitable for an indicated capacity, function, or usage, while taking into account that in some circumstances with a modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variations logically also subtend include phrases a varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claim should cover those variations.

Advances in science and technology may make equivalence and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of claims.

What is claimed is:

1. A method of enclosing a smart speaker device that allows sound waves to travel to and from the device with minimal interference while providing weather resistance, the method comprising:
providing a smart speaker enclosure, having:
a container like structure with a hollow chamber for a smart speaker to be inserted into and container closed with smart speaker inside by a lid;

2. A method of enclosing a smart speaker device of claim 1, where a wire that passes electricity to a circuit that uses a temperature sensor to activate a heating coil when temperature below a set level is detected;

3. A method of enclosing a smart speaker device of claims 1-2, where the material is transparent.

4. A method of enclosing a smart speaker device of claim 1-3, with ability to be attached to a vertical or horizontal surface.

5. A method of enclosing a smart speaker device of claims 1-2, where the smart speaker is any acoustic device.

6. A protective enclosure, comprising:
multiple layers of external wall extending around and at least partially defining an interior space for being
occupied by a smart speaker, wherein the external wall comprises
a side wall comprising
an exterior wall with multiple cavities in a pattern,
an interior wall with multiples cavities in a pattern,
a top entry cavity for a smart speaker to be covered
a top lid mounted over external wall with a hinge that is movable between an open position and a closed position;
a bottom base partially defining the interior space;
with a compartment for storing electronic components,
multiple hollow drainage cavities going through the base;

7. A protective enclosure of claim 5, wherein the number of internal walls with multiple cavities can be increased to an indefinite count based on application.

8. A protective enclosure of claim 5, where the enclosures external walls are made of plastic material.

9. A protective enclosure of claim 5, where the enclosures external walls are made of metal material.

10. A protective enclosure of claim 5, where the enclosures external walls are made of rubber material.

11. A protective enclosure of claim 5, where the enclosures external walls are made of metal PLA.

12. A protective enclosure of claim 5, where the enclosures external walls are made by a 3D printer.
